(19) United States
(12) Patent Application Publication
(10) Pub. No.: US 2007/0198996 A1
(43) Pub. Date: Aug. 23, 2007

(54) System and method for driving peripheral devices

(75) Inventors: Gary Chiu, Taipei Hsien (TW); Vincent Yang, Taipei Hsien (TW); David Y. Chang, Taipei Hsien (TW); Ling Huang, Taipei Hsien (TW); Wen Tsay, Taipei Hsien (TW)

Correspondence Address: BIRCH STEWART KOLASCH & BIRCH, PO BOX 747, FALLS CHURCH, VA, 22040-0747, US

(73) Assignee: ZIEP SOFTWARE INC.

(21) Appl. No.: 11/448,821

(22) Filed: Jun. 8, 2006

(30) Foreign Application Priority Data
Feb. 9, 2006 (TW) 95104447

(51) Int. Cl. G06F 9/46

(52) U.S. Cl. 719/321

(57) ABSTRACT

A driver installation free system including a peripheral storing a device driver, a host, an operation system, an application interface and a middleware is provided. When the peripheral device is coupled with the host, the middleware utilizes the bus driver to read a configuration of the peripheral device, the driver function information and the driver parameter structure from the peripheral device, and generates relationships between the standard command and the device driver command as well as between the standard parameter structure and the driver parameter structure.

### RELATED APPLICATIONS

The present application is based on, and claims priority from, Taiwan Application Serial Number 95104447, filed Feb. 9, 2006, the disclosure of which is hereby incorporated by reference herein in its entirety.

### BACKGROUND OF THE INVENTION

1. Field of Invention

The present invention relates to a system and method for driving peripheral devices, and more particularly, to an installation-free system and method for driving peripheral devices.

2. Related Art

Personal computers, personal digital assistants and smart phones are becoming more and more powerful due to the fast development of information technology. Those information devices can be used as hosts and can have their functions extended by connecting various peripheral devices thereto. However, when the peripheral devices are connected to the host, device drivers should be installed in the host to enable the host to communicate with the peripheral devices. For example, when a printer is connected to a personal computer, a printer driver should be installed in the personal computer to enable the personal computer to control the printer. Although peripheral devices with the Plug and Play interface can be driven without installing their device drivers in the host manually, the device drivers should be disposed in the host beforehand. The device driver installed in the host inconveniences users, as the device driver varies according to the operating system and the hardware of the host. The users should install proper device drivers for the peripheral devices or the peripheral device would not work. The device drivers are also bothersome for the developers of host's application software and device driver, as the architecture of the device drivers and the methods defined in the device driver for controlling the peripheral devices are pretty diversified.

Moreover, the communication protocol type should be chosen and then the device driver should be installed in the host on condition that the communication protocol used by the host and the peripheral devices is a wireless communication protocol. Those installation processes are complicated and troublesome to most users, even professional users.

For the forgoing reasons, there is a need for a system and a method for driving peripheral devices that can drive peripheral devices without having to install and configure the device driver thereof. Further, how to provide a system and method for driving peripheral devices in order to efficiently and conveniently develop the host's application software is an issue of great consequence for the software developers.

### SUMMARY OF THE INVENTION

In an aspect of the present invention, a system and method for driving peripheral devices is provided. The system and method can drive the peripheral devices without having to install or configure the device driver thereof. Consequently, the installation process of the peripheral devices can be simplified.

In yet another aspect of the present invention, a system and method for driving peripheral devices is provided. The system and method can simplify the development of the software executed in the host. Software developers can use the standard command to drive the peripheral device, so the variety of the device driver can be ignored in development of the application software of the host.

Accordingly, the present invention provides a system for driving peripheral device including a peripheral device, a device driver, a host, an operating system, an application program interface and a middleware. The device driver storing a piece of driver function information, at least one device driver command and a driver parameter structure is located in the peripheral device. The host is coupled with the peripheral device through a bus interface. The operating system with a bus driver for driving the bus interface is executed in the host. The application program interface is executed in the host. The middleware storing at least one standard command and a standard parameter structure is executed in the host and connected to the application program interface. When the peripheral device is coupled with the host, the middleware utilizes the bus driver to read a configuration of the peripheral device, the driver function information and the driver parameter structure from the peripheral device. The middleware generates relationships between the standard command and the device driver command as well as between the standard parameter structure and the driver parameter structure. When the peripheral device is driven by the application program interface, the middleware receives a request from the operating system and translates the request into the device driver command and the driver parameter structure by utilizing the standard command and the standard parameter structure. Then, the middleware transmits the device driver command translated from the request to the peripheral device.

The present invention also provides a method implemented in a host for driving peripheral devices. The host has a middleware and is coupled with a peripheral device. The method includes the following steps. Firstly, a piece of device information of the peripheral device is input to the host. The peripheral device has a device driver storing a piece of driver function information, at least one device driver command and a driver parameter structure. Next, the middleware storing at least one standard command and a standard parameter structure is loaded according to the device information. Then, a configuration of the peripheral device, the driver function information and the driver parameter structure are input and bound to the middleware. The middleware generates relationships between the standard command and the device driver command as well as between the standard parameter structure and the driver parameter structure, so that the standard command can be parsed into the device driver command and vice versa. Finally, a device driver command translated from a request is transmitted.

The present invention also provides a method implemented in a peripheral device for driving peripheral devices. The peripheral device has a device driver storing a piece of driver function information, at least one device driver command and a driver parameter structure. The method includes the following steps. Firstly, a host having a middleware is coupled to the peripheral device. The middleware stores at least one standard command and a standard parameter structure. Next, a piece of device information is transmitted to the host to enable the host to load the middleware according to the device information. Then, a configuration, the driver function information and the driver parameter structure are transmitted to the host to enable the host binding the configuration, the driver function information and the driver parameter structure to the middleware. The middleware generates relationships between the standard command and the device driver command as well as between the standard parameter structure and the driver parameter structure. Finally, a device driver command translated from a request is executed.

According to preferred embodiments, the device driver for driving the peripheral device is disposed in the peripheral device rather than the host, so the operating system of the host can be simplified.

According to preferred embodiments, the middleware executed in the host has at least one standard command and a standard parameter structure. It is not required to install different device drivers according to the peripheral device, so the installation process of the peripheral device can be simplified.

According to preferred embodiments, when the peripheral device is coupled with the host, the middleware utilizes the bus driver to read a configuration of the peripheral device from the peripheral device. The peripheral device can be easily set up, as the manual configuration process in the host is eliminated.

According to preferred embodiments, the middleware storing at least one standard command and a standard parameter structure is executed in the host and connected to the application program interface. When the peripheral device is driven by the application program interface, the middleware receives a request from the operating system and translates the request into the device driver command and the driver parameter structure by utilizing the standard command and the standard parameter structure. The software developers can use the standard command to drive the peripheral device, so the variety of the device driver can be ignored in developing the application software of the host.

It is to be understood that both the foregoing general description and the following detailed description are by examples and are intended to provide further explanation of the invention as claimed.

### BRIEF DESCRIPTION OF THE DRAWINGS

These and other features, aspects and advantages of the invention will become apparent by reference to the following description and accompanying drawings, which are given by way of illustration only, and thus are not limitative of the invention, wherein:

FIG. 1 is a schematic diagram of a system for driving peripheral devices of the present invention; and

FIG. 2 is a flow chart of a method for driving peripheral devices of the present invention.

### DETAILED DESCRIPTION OF THE PREFERRED EMBODIMENT

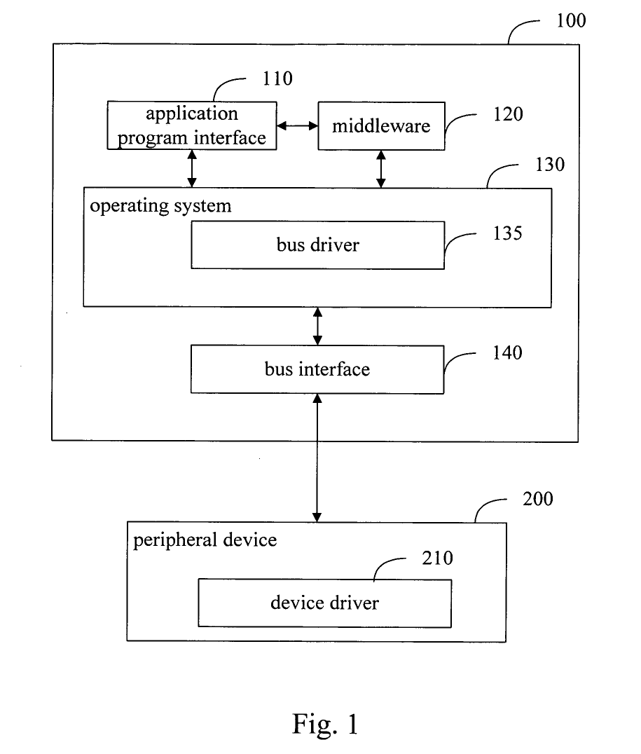

FIG. 1 depicts a schematic diagram of a system for driving peripheral devices of the present invention. Referring to FIG. 1, the system, which is free of an installed device driver, includes a peripheral device 200, a device driver 210, a host 100, an operating system 130, an application program interface 110 and middleware 120. The host 100 can be a personal computer, a personal digital assistant, a smart phone or some other electronic device with an operating system. The host 100 is coupled with the peripheral device 200 through a bus interface 140. The bus interface 140 can be a PCI interface, a PCI Express interface, a SDIO interface, a MMC interface or an IEEE1394 interface. The operating system 130, the application program interface 110 and the middleware 120 are executed in the host 100. The operating system 130, which can be a Microsoft Windows operating system, a LINUX operating system, a UNIX operating system, a MAC operating system or an embedded operating system, has a bus driver 135 for driving the bus interface 140. It is worthy to note that the device driver 210 for driving the peripheral device 200 is disposed in the peripheral device 200 rather than on the host 100. In more detail, the device driver 210 stores a part of the driver function information, including at least one device driver command and a driver parameter structure in the peripheral device 200. The configuration, the driver function information and the driver parameter structure can be in Extensible Markup Language (XML) format.

The middleware 120 storing at least one standard command and a standard parameter structure is executed in the host 100 and connected to the application program interface 110. When the peripheral device 200 is coupled with the host 100, the middleware 120 utilizes the bus driver 135 to read a configuration of the peripheral device 200, the driver function information and the driver parameter structure from the peripheral device 200. The middleware 120 generates relationships between the standard command and the device driver command as well as between the standard parameter structure and the driver parameter structure, so that the standard command can be parsed into the device driver command and vice versa. When the peripheral device 200 is driven by the application program interface 110, the middleware 120 receives a request from the operating system 130. Next, the middleware 120 translates the request into the standard command and the standard parameter structure; and further, into the device driver command and the driver parameter structure. Next, the middleware 120 transmits the device driver command translated from the request to the peripheral device 200 to complete the request. As mentioned above, the application program interface 110 can utilize the standard command of the middleware 120 to control the peripheral device 200 without having to install the device driver 210 in the host 100.

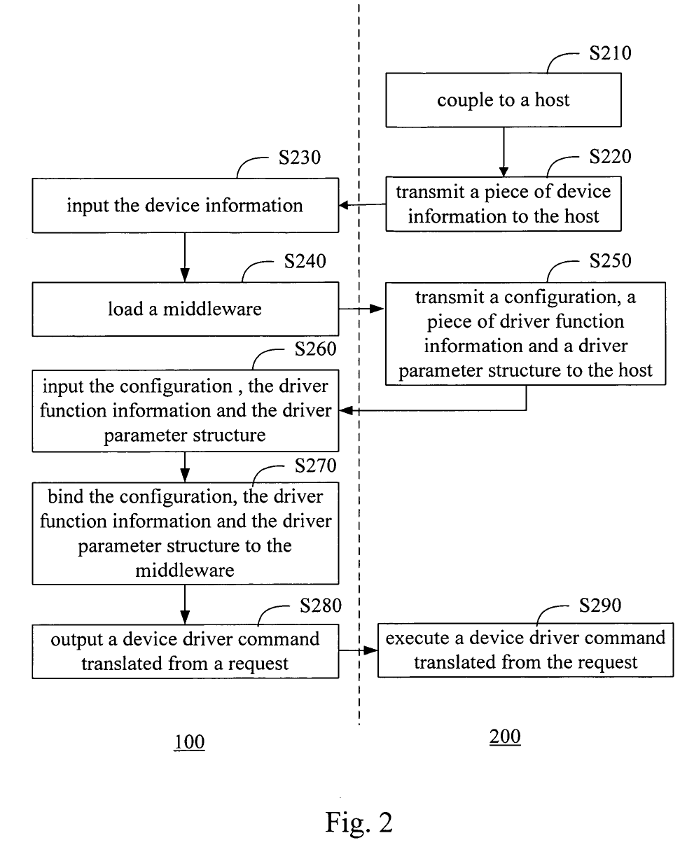

FIG. 2 depicts a flow chart of a method for driving peripheral devices of the present invention. Referring to FIG. 1 and FIG. 2, the method implemented in the host 100 and the method implemented in the peripheral device 200 are shown in the left half and the right half of FIG. 2 respectively. The host 100 executes the method to drive the peripheral device 200 and the peripheral device 200 executes the method to accept driving commands from the host 100. At first, in S210 the peripheral device 200 is coupled to the host 100. For example, the host 100 is coupled with the peripheral device 200 through the bus interface 140, which can be a PCI interface, a PCI Express interface, a SDIO interface, a MMC interface or an IEEE1394 interface. Next, in S220, a piece of device information is transmitted from the peripheral device 200 to the host 100. The device information may include a device type, a vendor ID and a device ID of the peripheral device 200. Next, in S230, the host 100 inputs the device information of the peripheral device 200 and the host 100 loads the middleware 120 in S240 according to the device information. It is worthy to note that the middleware 120 stores at least one standard command and a standard parameter structure.

Next, in S250, a configuration, a piece of driver function information and a driver parameter structure are transmitted from the peripheral device 200. The configuration, the driver function information and the driver parameter structure can be in simple data structure format or Extensible Markup Language (XML) format in order that the host 100 can interpret them easily. Next, in S260, the host 100 inputs the configuration, the driver function information and the driver parameter structure. In S270, the host 100 binds the configuration, the driver function information and the driver parameter structure to the middleware 120 to generate relationships between the standard command and the device driver command as well as between the standard parameter structure and the driver parameter structure. If, for example, a wireless peripheral device is installed in the host 100, the configuration includes the operation mode of the wireless peripheral device, which can be a ad-hoc mode or a access point mode, a service set identifier (SSID), a channel, and a security policy. The host 100 can be configured automatically by utilizing the configuration and the users need not configure the host 100 manually.

Next, in S280, the host 100 outputs a device driver command translated from a request to the peripheral device 200 and in S290 the peripheral device 200 executes the device driver command translated from the request. In more detail, when the application program interface 110 drives the peripheral device 200 to do a job, the operating system 130 transmits a request to the middleware 120. The middleware 120 receives the request and translates the request into the standard command and the standard parameter structure; and further, into the device driver command and the driver parameter structure. Then, the middleware 120 transmits the device driver command translated from the request to the peripheral device 200 through the bus driver 135. Finally, the peripheral device 200 executes the device driver command translated from the request to perform the job.

According to preferred embodiments mentioned above, the system and method for driving peripheral devices of the present invention has the following advantages. Firstly, the device driver for driving the peripheral device is disposed in the peripheral device rather than the host, so the operating system of the host can be simplified. Secondly, it is not required to install the device driver in the host, so the installation process of the peripheral device can be simplified. Thirdly, the software developers can use the standard command to drive the peripheral device, so the the device driver type can be ignored in the development of the application software of the host.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system comprising:
a peripheral device;
a device driver located in the peripheral device, the device driver storing a piece of driver function information, at least one device driver command and a driver parameter structure;
a host coupled with the peripheral device through a bus interface
an operating system executed in the host, the operating system having a bus driver for driving the bus interface;
an application program interface executed in the host ; and
a middleware executed in the host and connected to the application program interface, the middleware storing at least one standard command and a standard parameter structure, when the peripheral device is coupled with the host, the middleware utilizing the bus driver to read a configuration of the peripheral device, the driver function information and the driver parameter structure from the peripheral device, and generating relationships between the standard command and the device driver command as well as between the standard parameter structure and the driver parameter structure, when the peripheral device is driven by the application program interface, the middleware receiving a request from the operating system, translating the request into the device driver command and the driver parameter structure by utilizing the standard command and the standard parameter structure, and transmitting the device driver command translated from the request to the peripheral device.

2. The system of claim 1, wherein the bus interface is a PCI interface, a PCI Express interface, a SDIO interface, a MMC interface or an IEEE1394 interface.

3. The system of claim 1, wherein the host is a personal computer, a personal digital assistant or a smart phone.

4. The system of claim 1, wherein the operating system is a Microsoft Windows operating system, a LINUX operating system, an UNIX operating system, a MAC operating system or an embedded operating system.

5. The system of claim 1, wherein the configuration, the driver function information and the driver parameter structure are in Extensible Markup Language format.

6. A method for driving peripheral devices, the method implemented in a host, the host having a middleware and coupled with a peripheral device, the method comprising:
inputting a piece of device information of the peripheral device, the peripheral device having a device driver, the device driver storing a driver function information, at least one device driver command and a driver parameter structure;
loading the middleware according to the device information, the middleware storing at least one standard command and a standard parameter structure;
inputting a configuration of the peripheral device, driver function information and the driver parameter structure;
binding the configuration, the driver function information and the driver parameter structure to the middleware to generate relationships between the standard command and the device driver command as well as between the standard parameter structure and the driver parameter structure, so that the standard command can be parsed into the device driver command and vice versa; and
outputting a device driver command translated from a request.

7. The method for driving peripheral devices of claim 6, wherein the step of inputting the device information of the peripheral device comprises inputting the device information of the peripheral device through a bus interface of the host.

8. The method for driving peripheral devices of claim 7, wherein the bus interface is a PCI interface, a PCI Express interface, a SDIO interface, a MMC interface or an IEEE1394 interface.

9. A method for driving peripheral devices, the method implemented in a peripheral device having a device driver, the device driver storing a piece of driver function information, at least one device driver command and a driver parameter structure, the method comprising:
coupling to a host, the host having a middleware, the middleware storing at least one standard command and a standard parameter structure;
transmitting a piece of device information to the host to enable the host to load the middleware according to the device information
transmitting a configuration, the driver function information and the driver parameter structure to the host, the host binding the configuration, the driver function information and the driver parameter structure to the middleware to generate relationships between the standard command and the device driver command as well as between the standard parameter structure and the driver parameter structure; and
executing a device driver command translated from a request.

10. The method for driving peripheral devices of claim 6, wherein the configuration, the driver function information and the driver parameter structure are in Extensible Markup Language format.
